(19) United States
(12) Patent Application Publication
(10) Pub. No.: US 2013/0036073 A1
(43) Pub. Date: Feb. 7, 2013

(54) System and Method for Management of Financial Advisor Records

(71) Applicant: Roger E. Kiger, Knoxville, TN (US)

(72) Inventor: Roger E. Kiger, Knoxville, TN (US)

(21) Appl. No.: 13/647,497

(22) Filed: Oct. 9, 2012

Related U.S. Application Data
(60) Provisional application No. 61/553,744, filed on Oct. 31, 2011.

(51) Int. Cl. G06Q 40/06

(52) U.S. Cl. 705/36 R

(57) ABSTRACT

An interactive system for managing records of a financial advisor by a service provider on behalf of the financial advisor. The system includes a financial advisor management application that provides a user interface displayed on the financial advisor computer, which receives, stores, and provides information regarding clients, the financial advisor and the financial advisor practice via multiple system tools. One system tool, in particular, the regulatory compliance tool, monitors the information and creates and stores client files for complying with various financial audit requirements.

This invention claims all rights on and priority to U.S. provisional patent application 61/553,744 filed Oct. 31, 2011, titled SYSTEM AND METHOD FOR MANAGEMENT OF FINANCIAL ADVISOR RECORDS.

### FIELD

This invention relates generally to a system and method of managing records of a financial advisor. In particular, this invention relates to a computerized web-deployed records management system that collects and maintains compliance customer records related to the advising, developing a portfolio, investing funds and managing the investments of a customer.

### BACKGROUND

Vendors of software products aimed at the financial investment market have attempted to develop software packages to solve many of the problems that a financial investment company faces daily. These individual packages, which attempt to address those problems, are purchased separately and must be integrated together in an attempt to solve all the information management problems facing those companies. These software packages are often incompatible with one another and, accordingly, a system made by combining multiple applications often fails to provide adequate continuity for the user. In particular, one major shortcoming in the prior art relates to systems and methods for ensuring compliance with laws, regulations, and procedures. Various governmental and regulatory agencies require investment companies to maintain accurate and complete records of all their activities. The systems disclosed by the prior art produce inaccurate and incomplete records due, at least in part, to the compatibility issues between software packages. Furthermore, these systems are often cumbersome and inefficient to operate since a user must be knowledgeable of multiple software user interfaces.

Accordingly, what is desired is a simpler and more efficient system for meeting the record keeping needs of a financial investment company. Such a system should ensure consistent management of the interactive process between financial advisor and customer, improve compliance with financial reporting and audit requirements to minimize governmental investigations and the chance for legal action, and provide a comprehensive record of all customer and investment-related interactions.

### SUMMARY

The present invention is directed to an interactive system for managing compliance records of a financial advisor by a service provider on behalf of the financial advisor. The system includes a service provider computer in communication with a financial advisor computer via a communication network. The service provider computer includes a financial advisor management application that receives financial advisor information via the communication network and processes the financial advisor information in managing the records of the financial advisor.

The financial advisor management application provides a user interface displayed on the financial advisor computer, which is configured to prompt the financial advisor to input financial advisor information via multiple system tools. The system also includes a financial advisor records database in communication with the service provider computer, which stores the financial advisor information associated with the financial advisor account.

The system tools include a contact management tool, an electronic filing tool, a notes tool, a risk tolerance questionnaire tool, a regulatory compliance tool, a model generation tool, and a financial advisor summary tool. The user interface is further configured to provide the financial advisor access to the financial advisor information associated with a financial advisor account maintained by the service provider for the financial advisor. The contact management tool prompts the financial advisor to input information relating to prospective customers and existing customers into a customer file. The electronic filing tool allows the financial advisor to upload files for storage in the financial advisor records database including dictation and word processor documents. The risk tolerance questionnaire tool generates a series of questions to be answered by the customer that are used in determining a suggested investment model for that customer. The regulatory compliance tool monitors the financial advisor information and stores most required information for complying with various financial audit requirements to an audit/compliance file. The model generation tool provides financial advisor models and research related to each of those models. The financial advisor summary tool provides a summary of customers, customer contact information, customer assets, customer investments, and customer tasks to be performed by the financial advisor relating to each customer.

These and other aspects, objects, features and advantages of the present invention are set forth in the following Detailed Description and accompanying drawings.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 is a block diagram of an interactive system for managing records of a financial advisor according to embodiments of the present invention;

FIG. 2 is a flowchart of an exemplary process for investing the funds of a customer and monitoring those investments according to embodiments of the present invention;

FIG. 3 is a flowchart of an exemplary process for initializing the interaction of the present invention and defining user and customer profiles;

FIG. 4 is a flowchart of an exemplary process for investing the funds of a customer according to embodiments of the present invention;

FIG. 5 is a flowchart of an exemplary process for monitoring the investments of a customer according to embodiments of the present invention;

FIG. 6 depicts an exemplary user interface screen for adding or removing user accounts;

FIG. 7 depicts an exemplary user interface screen for viewing a summary of user accounts;

FIG. 8 depicts an exemplary user interface screen for viewing a table of funds selected by the financial advisor;

FIG. 9 depicts an exemplary user interface screen for adding funds to the funds table;

FIG. 10 depicts an exemplary user interface screen for uploading financial advisor operational materials

FIG. 11 is an exemplary user interface screen for uploading financial advisor marketing materials;

FIG. 12 depicts an exemplary user interface screen for uploading audit preparation materials;

FIG. 13 depicts an exemplary user interface screen for uploading compliance materials;

FIG. 14 depicts an exemplary user interface screen for uploading financial advisor resources;

FIG. 15 depicts an exemplary user interface screen for viewing a summary of customer profiles;

FIG. 16 depicts an exemplary user interface screen for adding or removing customer profiles;

FIG. 17 depicts an exemplary user interface screen for viewing and editing a selected customer profile;

FIG. 18 depicts an exemplary user interface screen for uploading information and documents to a selected customer profile;

FIG. 19 depicts an exemplary user interface screen for uploading financial planning information to a selected customer profile;

FIG. 20 depicts an exemplary user interface screen for uploading insurance information to a selected customer profile;

FIG. 21 depicts an exemplary user interface screen for uploading tax information to a selected customer profile;

FIG. 22 depicts an exemplary user interface screen for viewing investment account information to a selected customer profile;

FIG. 23 depicts an exemplary user interface screen for adding investment account information to a selected customer profile;

FIG. 24 depicts an exemplary user interface screen for viewing investment models for a selected customer profile;

FIGS. 25A and 25B depict an exemplary user interface screen for viewing a risk tolerance questionnaire;

FIG. 26 depicts an exemplary user interface screen for viewing customer fund allocations;

FIG. 27 depicts an exemplary user interface screen for viewing a customer appointment checklist; and

FIG. 28 depicts an exemplary user interface screen for viewing a Vision Gauge feature.

### DETAILED DESCRIPTION

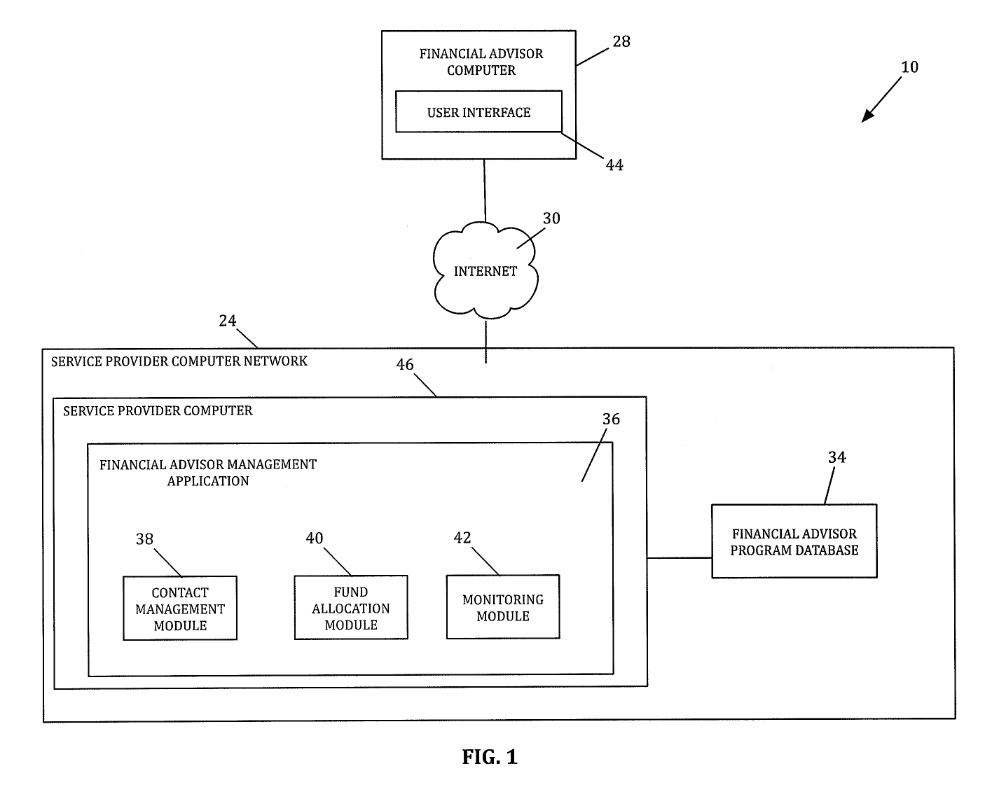

FIG. 1 depicts an interactive system 10 for managing records of a financial advisor. As described in more detail hereinafter, the interactive system 10 allows a user to monitor and manage the interactions between one or more financial advisors, the financial advising company, prospective customers, existing customers, and past customers. As the term is used herein, “user” refers generally to a user of the interactive system and may include one or more financial advisors, supervisors, etc.

As the term is used herein, “financial advisor” generally refers to an individual or a business entity that provides financial investment advice to a customer and/or is engaged in investing the funds of a customer into one or more financial investments. Additionally, the term “customer” refers to a person who is currently investing funds or may potentially invest funds into one or more investments using the services of the financial advisor. Finally, a “user” refers to anyone using the system 10 and may include, for example, a system administrator, a financial advisor.

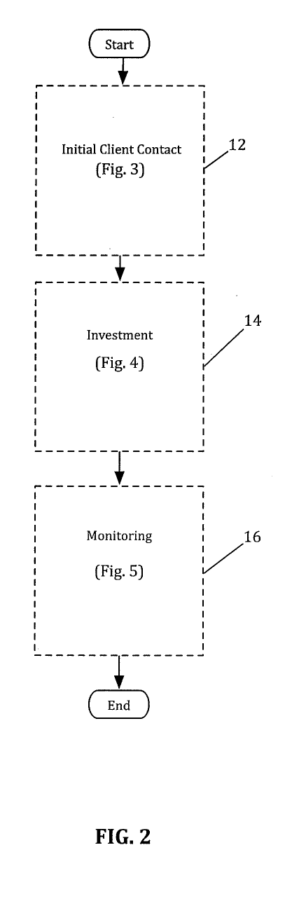

A customer often engages a financial advisor for the purpose of investing some or all of the investable funds of a customer into one or more assets and monitoring those assets to ensure the continued growth of the customer's invested funds. As shown in FIG. 2, this engagement may involve. three phases: (1) an initial customer contact phase 12, where the customer is introduced to the financial advisor and most information relating to the customer is collected by the financial advisor; (2) an investment phase 14, where the customer and/or advisor make investment decisions and invest funds of the customer; and (3) a monitoring phase 16, where the investments are monitored and adjusted as needed. Throughout the engagement, the customer's preferences should remain a dominant concern for the financial advisor. For that reason, the interactive system 10 incorporates the customer's investment style and risk tolerance throughout the interaction processes.

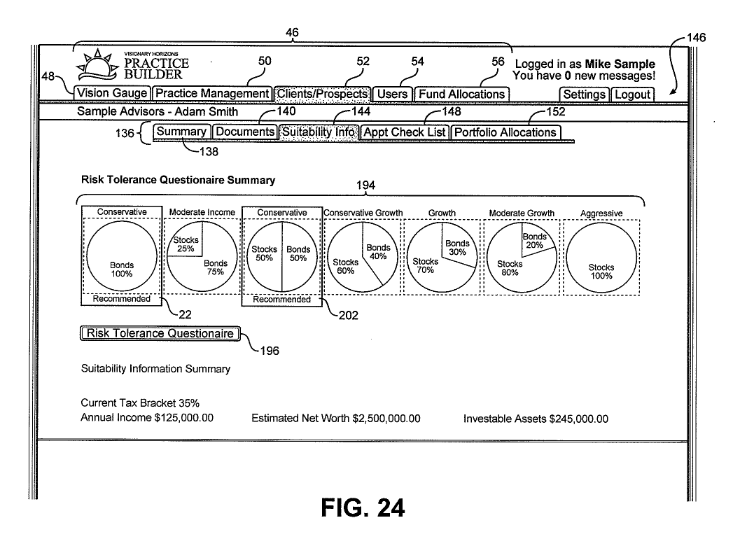

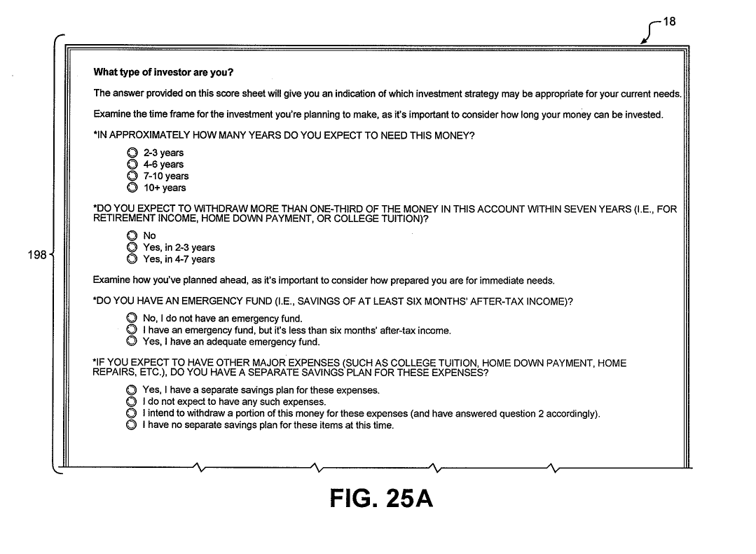

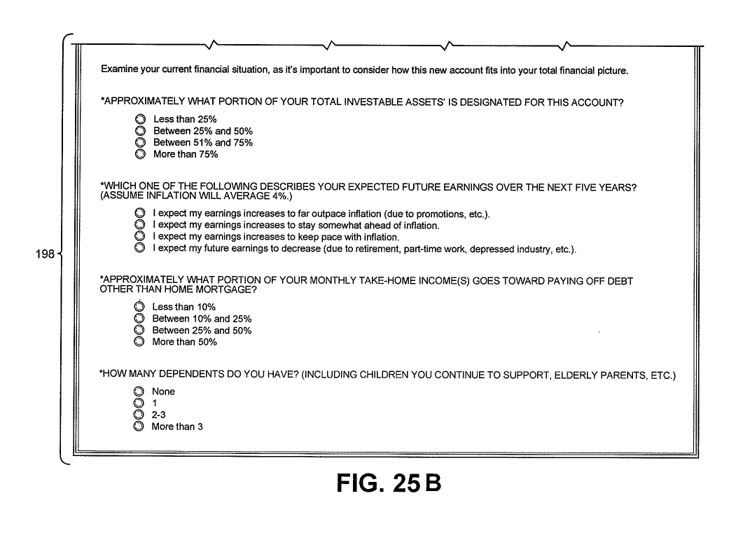

During the initial customer contact phase 12, the financial advisor determines the customer's risk tolerance and investment style via a risk tolerance questionnaire 18 (FIG. 25). During the investment phase 14, the financial advisor uses the interactive system 10 to match the customer's investment style and risk tolerance with the customer's investable assets to generate one or more model portfolios 20 and to recommend one of those models to the customer, a recommended model 22 (FIG. 24), that best suits the customer, and then invest some or all of those funds into a selected model or a combination of various models and/or individual funds. Finally, during the monitoring phase 16, the financial advisor monitors the customer's selected investments to ensure that the customer's portfolio of investments maintains the same or similar risk and investment characteristics that the customer initially desired. Alternatively, a customer's investment habits (e.g., risk tolerance and investment goals) may change over time and the portfolio may be modified to reflect these changes. For example, as a customer ages, they may become less risk tolerant and more risk averse.

Referring again to FIG. 1, the system 10 includes a service provider computer network 24, maintained by a service provider, and a financial advisor computer 28 which communicate with each other via a communication network 30 such as the Internet. Within the service provider computer network 24 is a service provider computer 32 which may be in communication with several components including, for example, a financial advisor program database 34. In a preferred embodiment, the service provider computer 32 executes a financial advisor management application 36, which assists the financial advisor by providing several integrated management modules including a contact management module 38, a fund allocation module 40, and a monitoring module 42. Each of these modules will be explained in greater detail hereinafter.

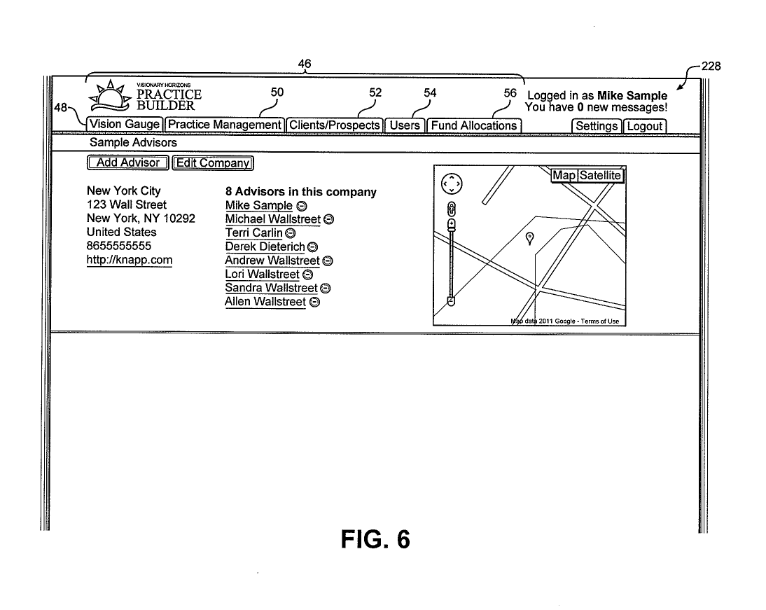

The financial advisor computer 28 may include, for example, a desktop computer, a laptop computer, a tablet computer, or a smart phone. A browser application loaded on the financial advisor computer 28 provides access to a service provider website via the Internet 30. In general, a user operates the aforementioned modules by interacting with a user interface 44 on the financial advisor computer 28. The user interface 44 may display several webpages that are accessed using navigation buttons 46 to facilitate this interaction, examples of which are shown in FIGS. 6-8.

By selecting one of the navigation buttons 46, a user can access various webpages to interact with the modules of the application 36 or access information stored on the financial advisor program database 34. As shown in FIG. 6, the navigation buttons 46 may include, for example, a Vision Gauge' button 48, a financial advisor management button 50, a customers/prospects button 52, a users button 54, and a fund allocations button 56.

Initial Customer Contact Phase

The system 10 includes a contact management module 38 for assisting the financial advisor in managing the process of initializing, processing, and managing all customers. The contact management module 38 includes computer-executable instructions that, when executed, allow a financial advisor to store information in the financial advisor program database 34 for all interactions with the customer, customer preferences, customer relationships, and notes pertaining to the customer, throughout all stages of the advisor-customer relationship.

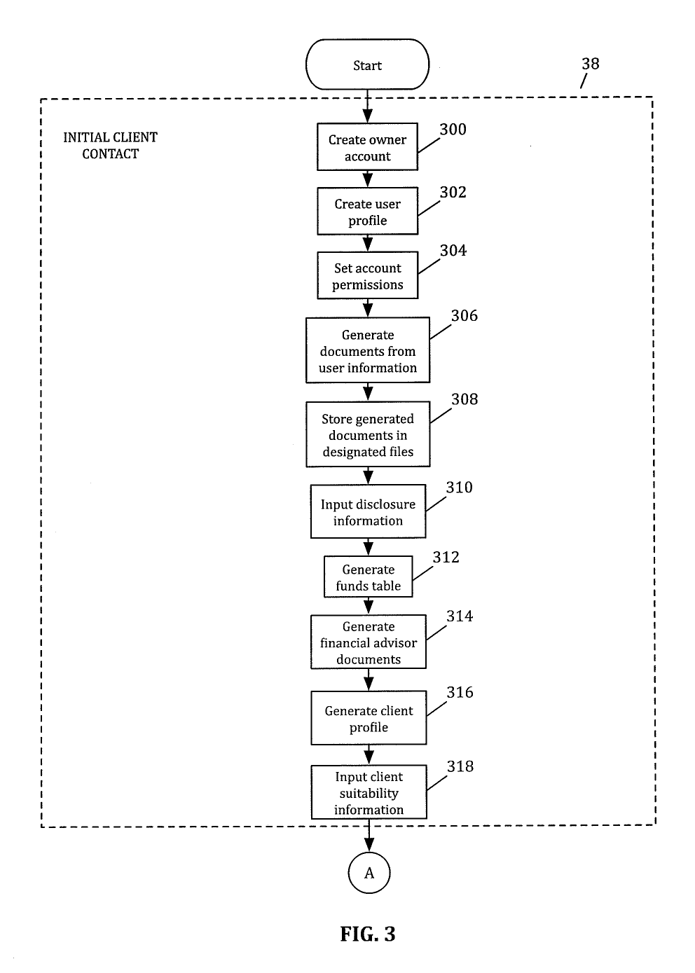

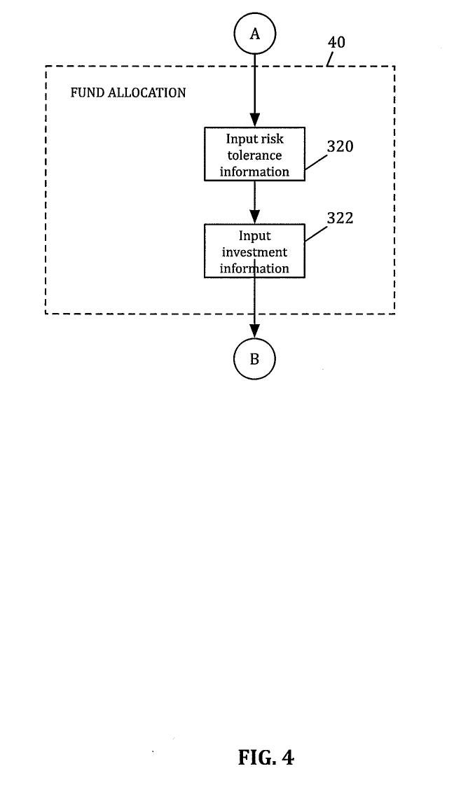

When initially activated, the application 36 contains no stored information relating to customers or financial advisors. Referring now to FIG. 3, before a user can gain access to the system 10, at least one owner account must be created (step 300). An owner account is an account that is generated for an owner who has an account with the service provider, where the service provider manages the records of the account holder and all users associated with that account holder. One or more user profiles 60 may be associated with a single owner account. One benefit of having an owner account is that it provides the service provider a single point of contact for billing and communicating with all users associated with the account.

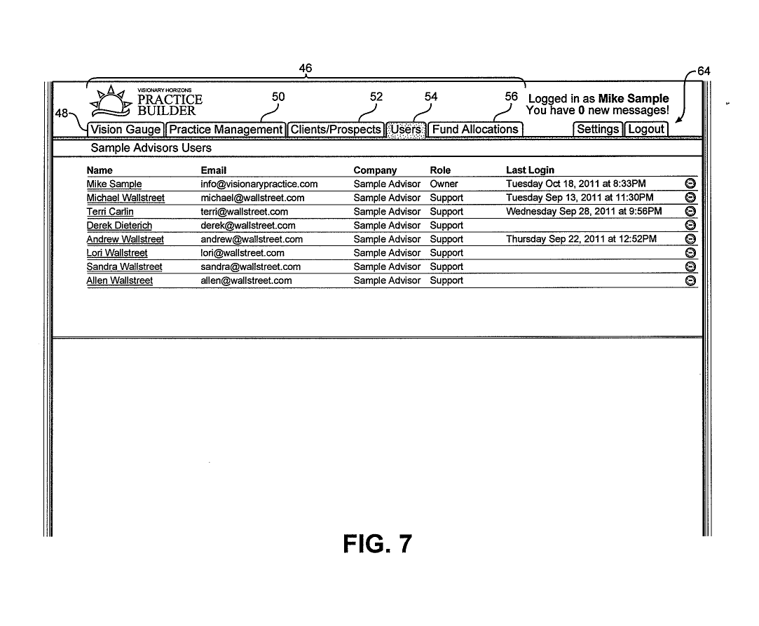

After the owner account has been created, one or more user profiles 60 must be created within that account (step 302). User profiles 60 are generated within the application 36 using a new user webpage 228 as shown in FIG. 6. Once a user profile 60 is created, the user name corresponding to that profile appears in a user summary webpage 64 shown in FIG. 7. User profiles 60 may be generated by the service provider or by the owner of the account with the service provider. Preferably, the owner will generate all required user profiles 60.

The user profile 60 is a record unique to each user and contains all information relating to that user including, for example, personal information, customer information, portfolio information and contact information. User profiles 60 may have different levels of access to the functions and pages of the application 36, depending on the permissions associated with the profile.

Permissions determine how the application 36 responds and appears to the user for whom those permissions were set. After creating a user profile, permissions are set for the profile (step 304), and depending on the permissions set for each user profile 60, portions of the application 36 (e.g., forms, webpages, or functions) may become accessible or inaccessible. For example, if a user profile 60 is created for a human resources employee, the permissions set for that profile may allow new user profiles 60 to be created for new employees but may also restrict access to the investing features of the application 36. In another example, if the user profile 60 is created for one financial advisor, that user profile may have access to the advising and investment tools but would not have access to human resources information or information relating to customer's that are associated with another financial advisor's user profile. Accordingly, based on the permissions that are set, user profiles 60 may or may not have the same access as the owner account. Preferably, the user profiles 60 include one or more permissions, which restrict access to various features or pages of the application 36 for that user.

After a user profile 60 has been created and saved to the database 34, the user name corresponding to the profile 60 will appear on a user summary webpage 64 as shown in FIG. 7. When the user selects a users button 54, as shown for example in FIG. 7, the application 36 executes the contact management module 38 and displays the user summary webpage 64. The user summary webpage 64 displays a list of all user profiles 60 and a portion of the information stored for that customer profile. For example, the user summary webpage 64 may provide contact information for each user (e.g., user names, email addresses, or phone number), which company the user is associated with, the role 68 of the user, and the date that the user last logged into the system 10. In addition to viewing user information that has been stored in the database 34, the user summary webpage 64 may also allow user profiles 60 to be added or deleted.

User information that is stored in the database 34 is automatically prefilled by the system 10 (step 306) into forms, correspondence, or other documents that are created by or for the financial advisor including, for example, letterhead or marketing materials. Once generated, these forms are stored by the application 36 in predetermined electronic files (step 308) that are created on the database 10 for ensuring reporting and documentation requirements.

Each user profile 60 may include several additional fields in which information can be included and stored to the database 34. While some of these fields may be optionally left unanswered, other fields are required. In particular, in initializing the system 10, the user must enter and save disclosure information (step 310) into the database. Disclosure information includes a disclosure statement which provides, among other things, the advisor's name, what products the advisor offers, the fees charged by the advisor, and what commission or other incentives the advisor takes in the course of trading. This disclosure statement should be provided to all customers before the financial advisor carries out any advising or investment activities on behalf of those customers. Therefore, to ensure that the disclosure information is entered, the system 10 requires the financial advisor to enter the disclosure information before other investment and advising tools can be accessed using the application 36. In a preferred embodiment, the user provides disclosure information to a system administrator or the service provider who then associates that information with that user's profile 60 when the user profile is initially created.

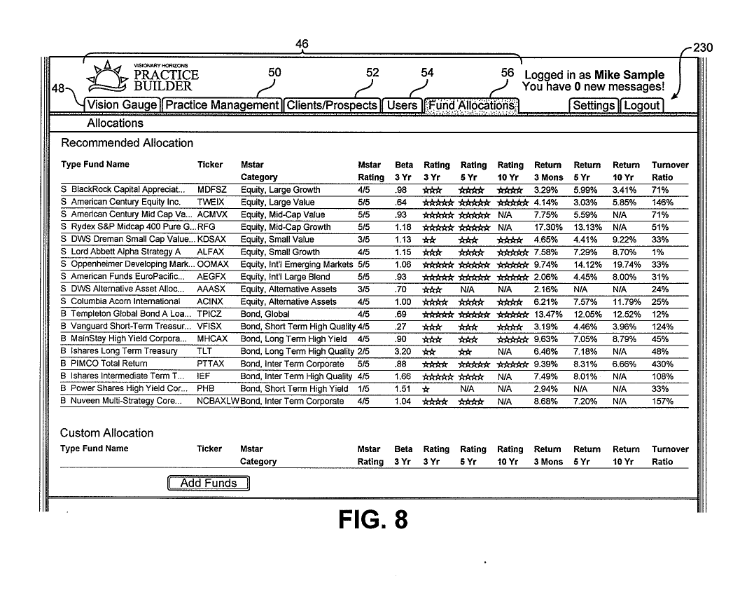

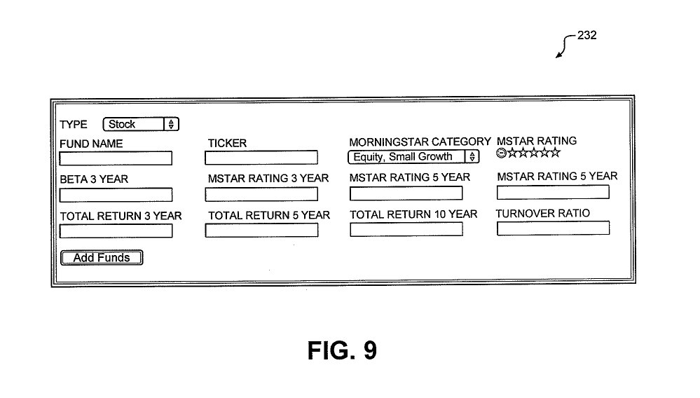

Finally, the service provider then creates a funds table 74 (step 312) that is associated with owner account as shown on a fund allocation webpage 230 shown in FIG. 8. The funds table 74 provides a listing of funds that the account owner and/or the users have in which selected to invest the assets of their customers. New funds are created using a new fund webpage as shown in FIG. 9.

Funds may be sorted into three categories: (1) “stocks,” (2) “bonds,” or (3) “other” (e.g., real estate or privately held companies). Within these three broad categories, funds may be further divided into several categories. For example, stocks and bonds may be categorized according to a categorizing system such as the Morningstar categories (e.g., large value, mid-cap value, small growth, etc.). Alternatively, the various funds may be listed individually. The categories assist financial advisors in making comparisons between similar funds, to build well-diversified portfolios, assess potential risk, and identify funds that perform well. When the fund table 74 is being generated, the financial advisor selects one fund that corresponds to each category or individually listed funds be selected.

Once selected, these funds are then saved to the database 34 and that data is used to populate the fund table 74. The fund table 74 may be modified at any time and, as further explained below, the system 10 may adjust certain values, settings, or decisions when any modification to the assets comprising the fund table are adjusted. To modify, add or remove funds from the fund table 74, the financial advisor, may make a request to the service provider requesting this alteration. The service provider may then update the table 74 accordingly to the request. Once the funds have been entered into the fund table 74, the financial advisor can begin investing funds of customers into one or more of the assets comprising the fund table 74.

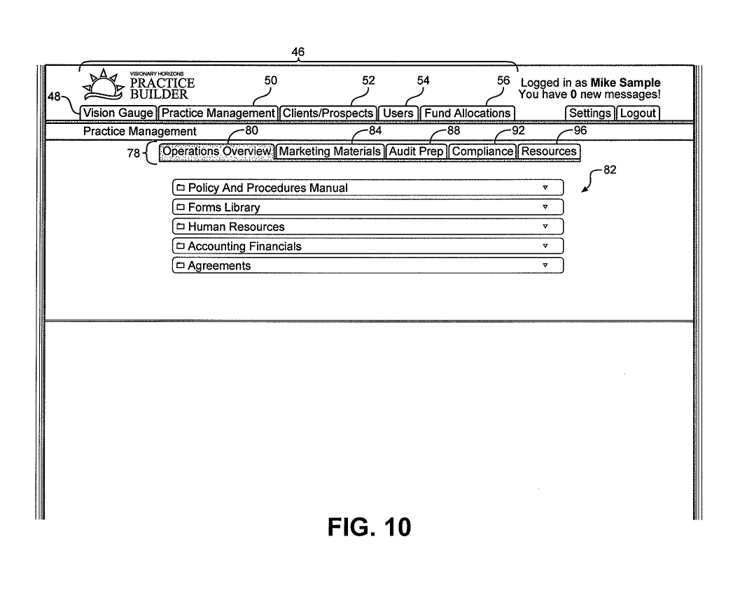

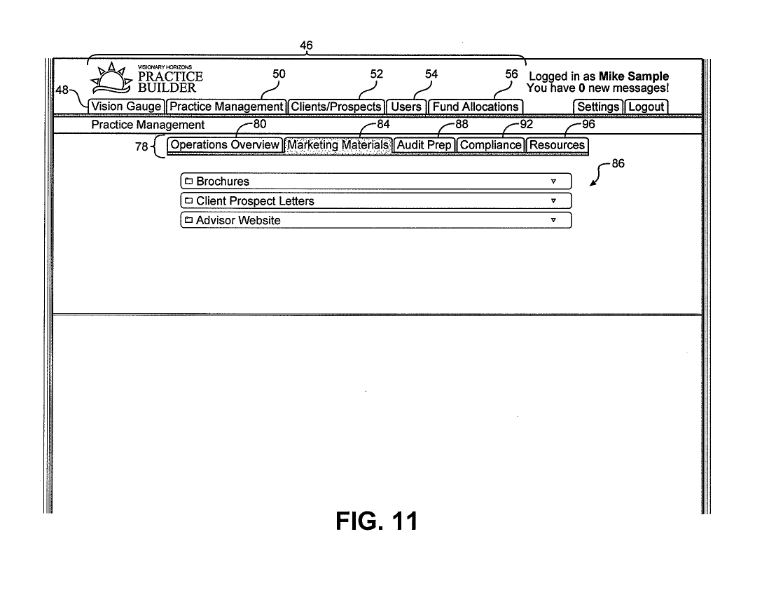

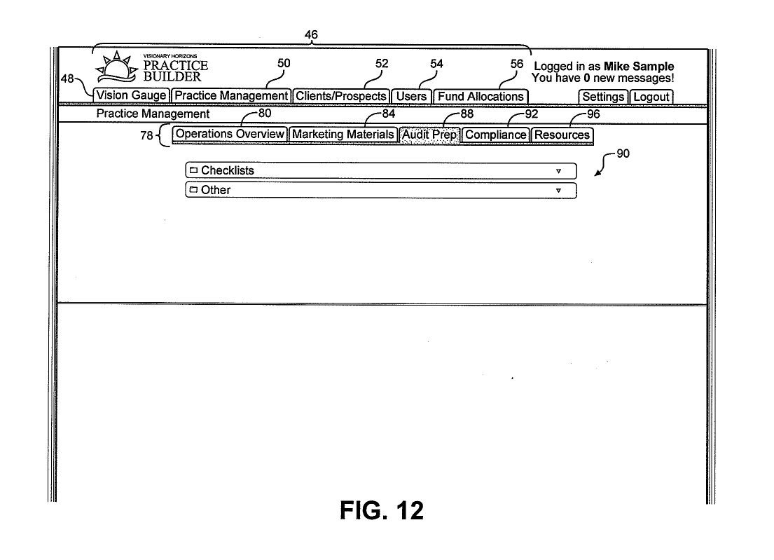

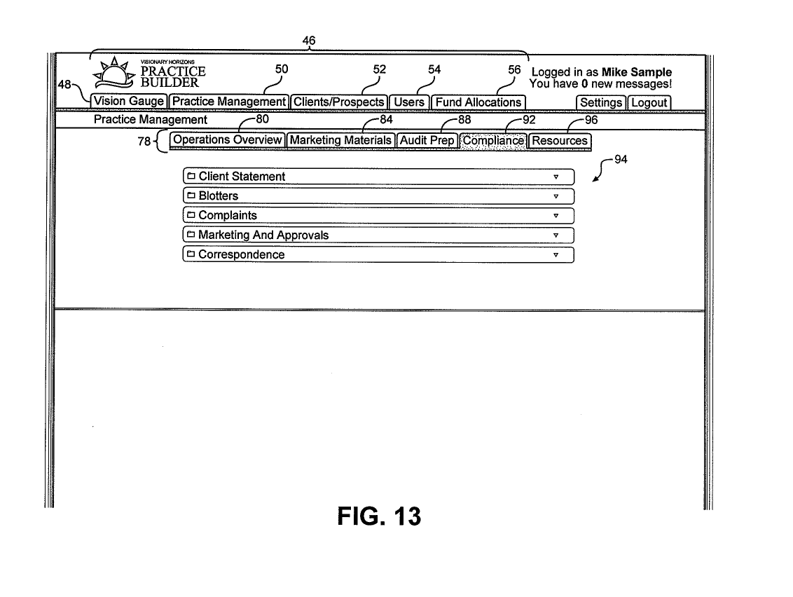

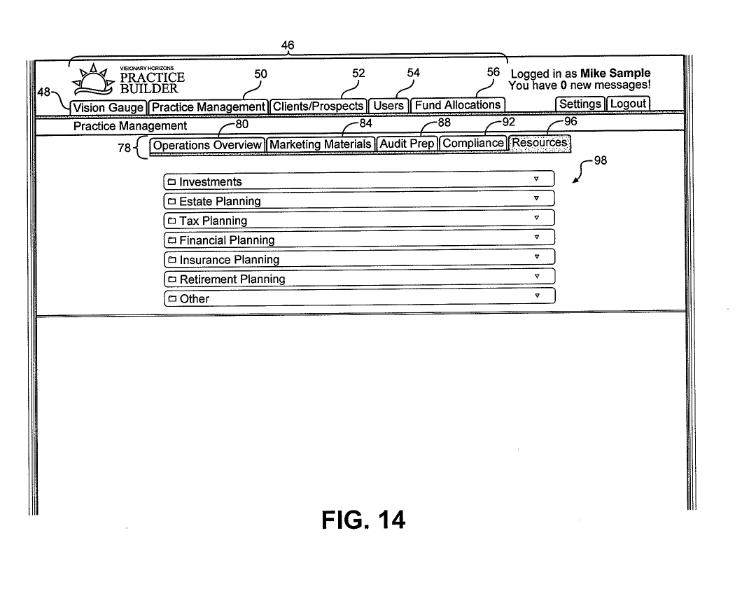

Once an owner account is activated, the system 10 provides several tools for managing the business of the financial advisor. In particular, a monitoring module 42 includes computer-executable instructions that, when executed, allows a user to manage non-customer business-related tasks. By selecting a financial advisor management button 50, the user can access multiple practice management pages as shown in FIGS. 10-14. These pages include several tabs 78 for navigating between the practice management webpages, for example, an “operations overview” tab 80 for navigating to an operations overview webpage 82 (FIG. 10), a “marketing materials” tab 84 for navigating to a marketing materials webpage 86 (FIG. 11), an “audit prep” tab 88 for navigating to an audit prep webpage 90 (FIG. 12), a “compliance” tab 92 for navigating to a compliance webpage 94 (FIG. 13), and a “resources” tab 96 for navigating to a resources webpage 98 (FIG. 14). As further detailed below, each of the aforementioned webpages in the monitoring module 42 allows the user to save information to the database 34, which acts as a repository for managing files of the financial advisor.

As shown in FIG. 10, the operations overview webpage 82 allows a user to upload documents relating to the business including, for example, policies, manuals, forms, human resources documents, accounting documents, and agreements.

As shown in FIG. 11, the marketing materials webpage 86 allows a user to upload documents relating to the marketing efforts of the business including, for example, brochures, customer prospect letters, and website documentation.

As shown in FIG. 12, the audit prep webpage 90 allows a user to upload documents relating to or required during audits including, for example, audit checklists or other documents.

As shown in FIG. 13, the compliance webpage 94 allows a user to upload documents relating to compliance with various regulatory or governmental requirements (e.g., SEC or FINRA) including, for example, customer statements, blotters (e.g., trade blotters or check blotters), complaints, marketing and approval documents, and other correspondence.

Finally, as shown in FIG. 14, the resources webpage 98 allows a user to upload other general documents that are useful to the financial advisor including, for example, investments documents (e.g., investments research), and other business-related or business planning documents.

In a preferred embodiment, the system 10 may optionally provide a date and time stamp 100 for any documents, notes or other information entered into the system as well as an indication of the user that uploaded or entered the documents, notes or other information.

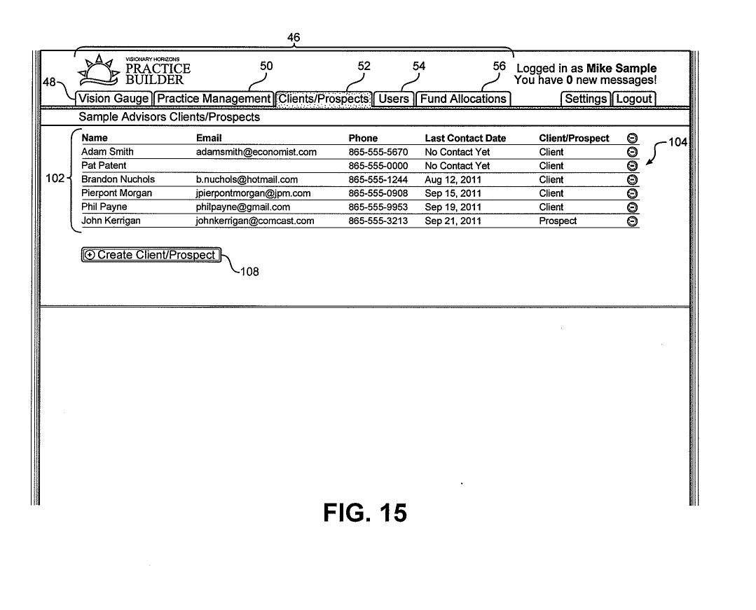

Next, in addition to managing owner accounts and user profiles 60, the system 10 may also be used to create one or more customer accounts 102 (FIG. 15). When a customer wishes to engage the services of the financial advisor (i.e., open an investment account using the services of a financial advisor) and contacts the financial advisor, one or more customer profiles 102 are created for the customer (step 316).

A customer profile 102 is a record unique to each customer and contains all information relating to that customer including, for example, personal information, investment information, and contact information. The customer profile 102 is generated within the application 36 using the contact management module 38 and all information associated with the customer profile 102 is saved to the database 34. In certain embodiments, one or more people may be associated with a single customer profile 102. For example, a husband and wife may be associated with a single customer profile 102. In another example, two business partners may be associated with a single profile 102.

When the user selects a customers/prospects button 52, shown for example in FIGS. 10-18, the application 36 executes the contact management module 38 and displays a customer overview page 104 (FIG. 15). The customer overview page 104 displays a list of customer profiles 102. On the customer overview page 104, the user can view a summary of customers information including, for example, customers status (i.e., whether they are a “customer” or a “prospect”), contact information for customers (e.g., customer's name, email address, phone number), the last date that each customer was contacted by a financial advisor, customer contact preferences, and upcoming meetings or required contacts with each of the customer.

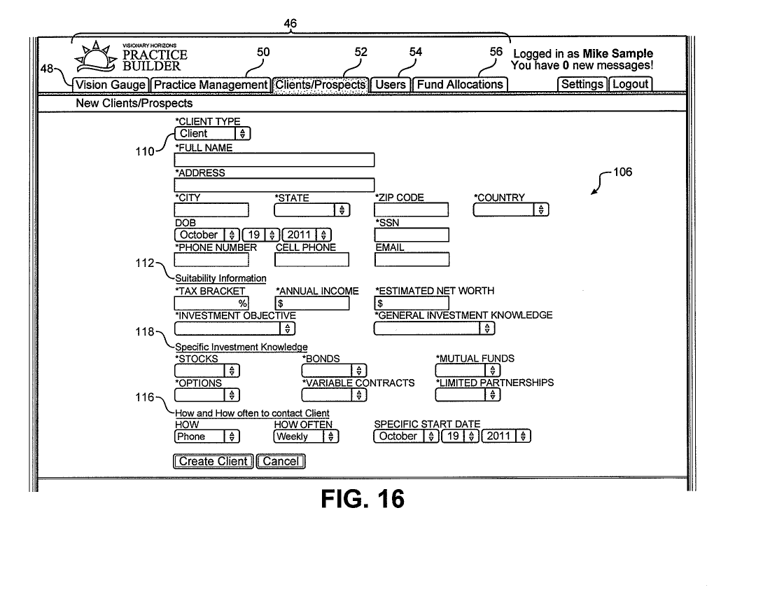

The information shown on the customer overview page 104 and other information is input into the system 10 when a customer profile 102 is created for the customer. The financial advisor may browse to a new customer webpage 106 for creating a new customer profile 102 from the customer overview page 104 by selecting a new customer button 108. As shown in FIG. 16, on the new customer webpage 106, the financial advisor may input customer contact information, designate customer status (i.e., whether they are a “customer” or a “prospect”) using a customer status indicator field 110, input suitability information, input customer contact preferences, and input investment knowledge information. As previously discussed, once this information is entered and saved to the database 34, it will appear on the customer overview page 104.

Using a suitability section 112 of the new customer webpage 106 (FIG. 16), the financial advisor can input suitability information relating to the customer (step 318). Suitability information includes, for example, the customer's current tax bracket, annual income, estimated net worth, investment objectives, and general investment knowledge. Investment objectives are an indication of what the customer ultimately hopes to achieve by investing their funds and may include, for example, (1) “Preservation of Capital,” (2) “Income,” (3) “Capital Appreciation,” (4) “Speculation,” and (5) “Trading Profits.” General investment knowledge is an indication of how knowledgeable the customer is with regard to financial investing, and may include, for example, (1) “limited,” (2) “good,” (3) “extensive,” or (4) “professional trader.” This will assist the financial advisor in responding to the particular needs of a customer and ensuring that they are given the type of attention and advice appropriate for their level of investment knowledge.

As shown in FIG. 16, a financial advisor may include any contact preferences 114 of the customer using a customer contact preferences field 116. Using the customer contact preferences field 116, the financial advisor can designate how the customer prefers to be contacted by the financial advisor (e.g., phone, text, email, letter), how often a customer should be contacted (e.g., weekly, monthly, etc.), and when contact with the customer should begin (e.g., after Sep. 15, 2011). For example, a user can note that a particular customer prefers phone contact to email contact and that the customer prefers to be contacted every bi-weekly.

In addition to general discussion, such contact between customer and advisor may be for the purpose of rebalancing the customer's portfolio. As further discussed herein, portfolios need to be “rebalanced” from time to time to ensure that the assets making up the portfolio accurately reflect the model upon which the portfolio was built. Therefore, a financial advisor may indicate certain “rebalance” meetings where a customer's portfolio is analyzed and any necessary trades are made to rebalance it. Like other meetings, these rebalance meetings can occur at certain intervals that are set by the advisor.

Finally, the financial advisor can further define a customer's investment knowledge with more particularity under a specific investment knowledge field 118. In some embodiments, for example, the specific investment knowledge field 118 may include a customer's investment knowledge with respect to stocks, bonds, mutual funds, options, variable contracts, and limited partnerships. This will further assist the financial advisor in responding to the particular needs of a customer. This information is particularly helpful to the financial advisor in serving customers that have some investment knowledge with respect to some types of investments, but limited knowledge with respect to other types of investments.

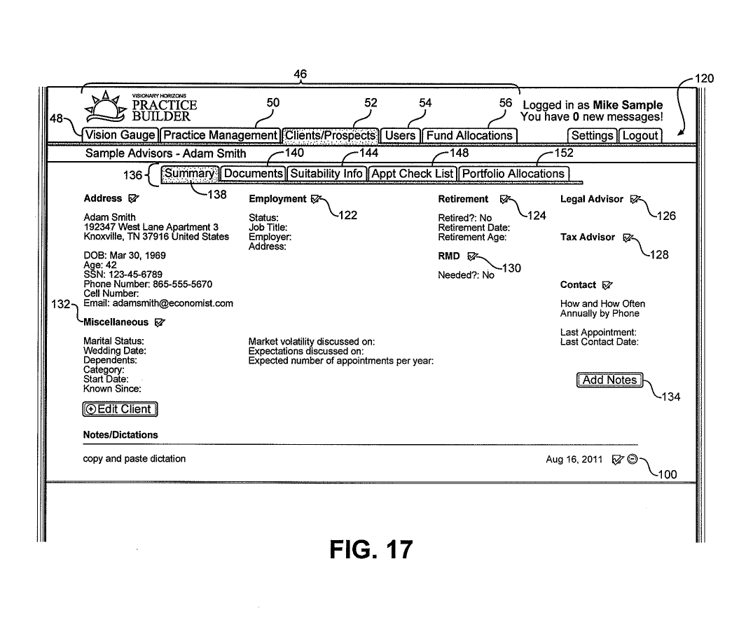

After creating and saving the customer profile 102, some of the customer's information is displayed on the customer overview page 104 (FIG. 15). Using the contact management module 38, a user can further modify the profile 102 by selecting the customer's name from the customer overview page 104. The application 36 then displays a customer profile webpage 120 shown in FIG. 17, where a financial advisor can view stored customer information, edit stored customer information, and add new customer information in various information fields.

For example, using an employment information field 122, a financial advisor may store and view the customer's employment status, job title, employer, and work address. In a retirement information field 124, a user can denote and view a customer's retirement status, the date of the customer's planned or actual retirement, and the age at which the customer retired or plans to retire. In a legal advisors field 126, a user may indicate existing relationships with legal advisors and view attorneys or law firms with which the customer is or has been associated. In a tax advisors field 128, a user may indicate existing relationships with tax professionals (e.g., accountants or bookkeepers) with which the customer is or has been associated. In an RMD field 130, the financial advisor can designate whether a required minimum distribution (RMD) is required for the customer. RMDs generally refer to minimum amounts of funds that a retirement plan customer must withdraw annually starting with the year that he or she reaches 70½ years of age or, if later, the year in which he or she retires. Additional fields may be added to describe other past or existing relationships involving the customer including, for example, any relationships with financial advisors.

Finally, additional information may be stored using a miscellaneous field 132 such as marital status, wedding date, tax dependents, notes or dictation. Notes and dictation may be added to the customer profile 102 by selecting a notes button 134.

In a preferred embodiment, the system 10 may optionally provide a date and time stamp 100 for any documents, notes or other information entered into the system as well as an indication of the user that uploaded or entered the documents, notes or other information.

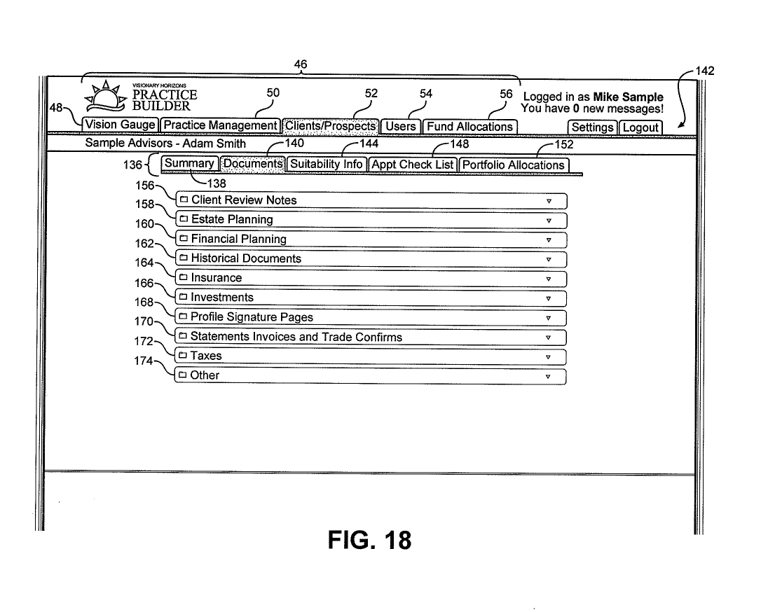

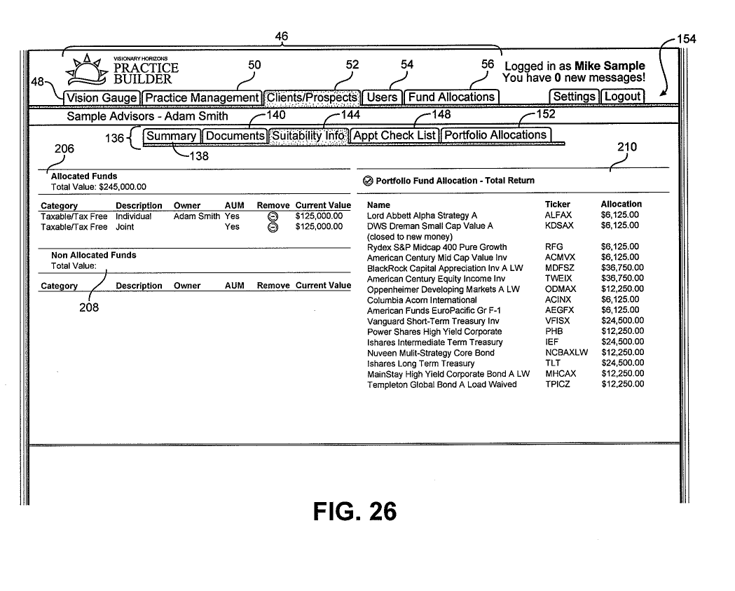

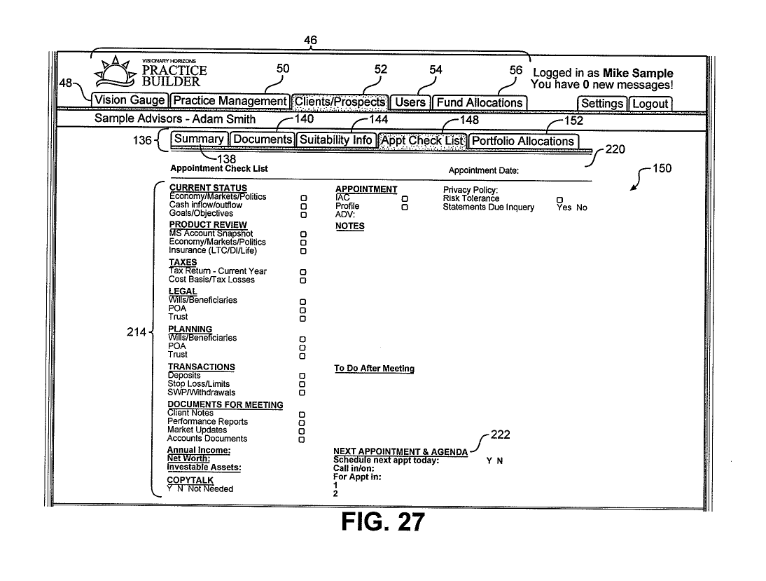

With continued reference to FIG. 17, the customer profile webpage 120 also displays a customer tab field 136 that includes several tabs for navigating between various webpages within the customer profile 102. The tab field 136 may include, for example, a “summary” tab 138 for navigating to the aforementioned customer profile webpage 120, a “documents” tab 140 for navigating to a customer documents webpage 142 (shown in FIG. 18), a “suitability info” tab 144 for navigating to a suitability and risk tolerance webpage 146 (shown in FIG. 24), an “apt. checklist” tab 148 for navigating to an appointment checklist webpage 150 (shown in FIG. 27), and a “portfolio allocations” tab 152 for navigating to an allocations webpage 154 (FIG. 26).

After information relating to a customer and information relating to the financial advisor has been uploaded, many additional features of the application 36 become available. Among these additional features, is the ability for the financial advisor to upload and save documents to the customer file and also for compliance purposes. Referring now to FIG. 18, the customer documents page 142 provides a centralized location for storing and viewing all documents that are generated or collected on behalf of the customer's investment activities. Documents may be uploaded and stored in the database 34 through the documents page 142 including, for example, within a notes folder 156, an estate planning folder 158, a financial planning folder 160, an historical documents folder 162, an insurance folder 164, an investment folder 166, a profile signature pages folder 168, an investment statements folder 170, a tax information folder 172, and an other documents folder 174.

Each folder provided on the customer documents page 142 is provided with either an upload button or an add button that allows the user to manually input information. For instance, documents relating to a customer's estate such as a will or life insurance policy may be uploaded to the estate-planning folder 158, tax returns and other tax documents may be uploaded to the tax information folder 172, and mortgages or other debt instruments may be uploaded to the financial planning folder 160. Additionally, contact with or correspondence concerning the customer, including written or electronic (e.g., email or fax), can be stored to the database 34 using one or more the folders on the customer documents page 142. In a preferred embodiment, the system 10 may optionally provide a date and time stamp 100 (FIG. 17) for any documents, notes or other information entered into the system as well as an indication of the user that uploaded or entered the documents, notes or other information.

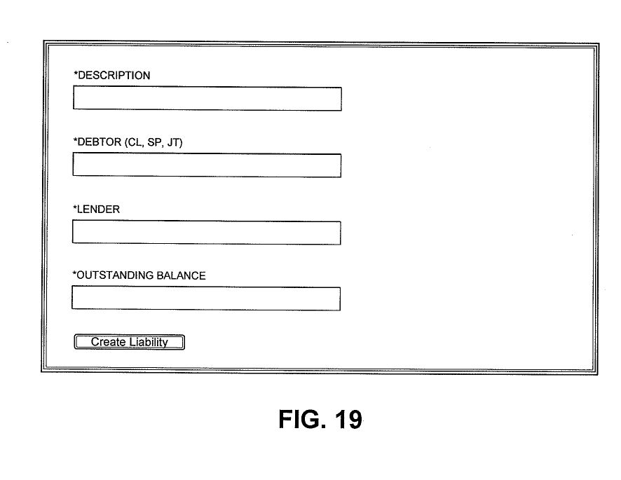

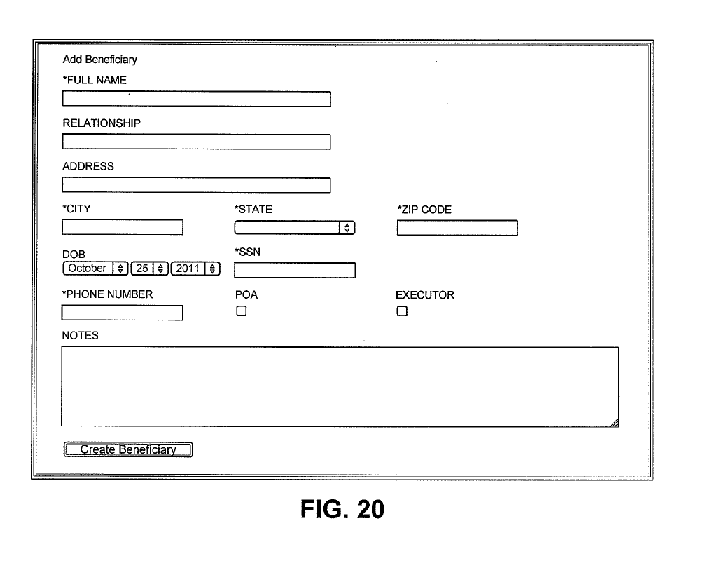

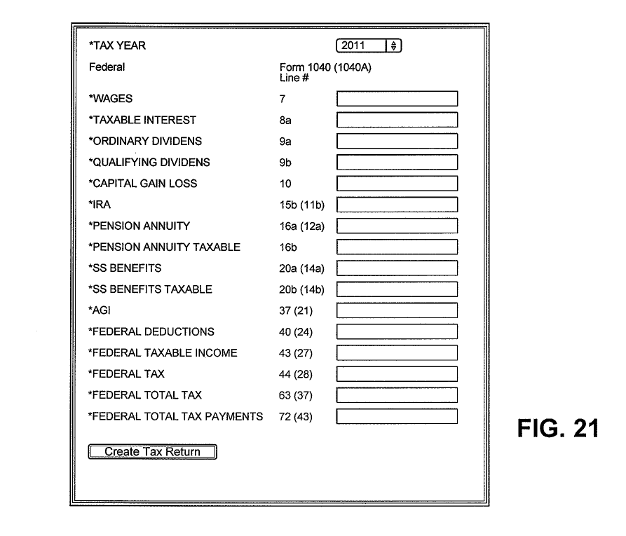

Using the various folders on the customer documents webpage 142, documents may be uploaded and stored in the database 34 and may be associated with a particular user profile 60 and/or a particular customer profile 102. For example, FIG. 19 shows a form in the estate-planning folder 158, where a user can provide liability information for a debt held by the selected customer, FIG. 20 shows a form in the insurance folder 162, where a user can provide insurance information for the selected customer, and FIG. 21 shows a form in the tax folder 172, where a user can provide tax information (e.g., tax returns) for the selected customer.

In a preferred embodiment, the system 10 may optionally provide a date and time stamp 100 for any documents, notes or other information entered into the system as well as an indication of the user that uploaded or entered the documents, notes or other information.

In other embodiments, information related to each user profile 60 and/or customer profile 102 may be exported in one or more file formats. For example, customer contact information and preferences may be exported to an address book in a CSV, TXT, or XLS file formats. Additionally, meetings and meeting reminders may be exported to a calendaring tool.

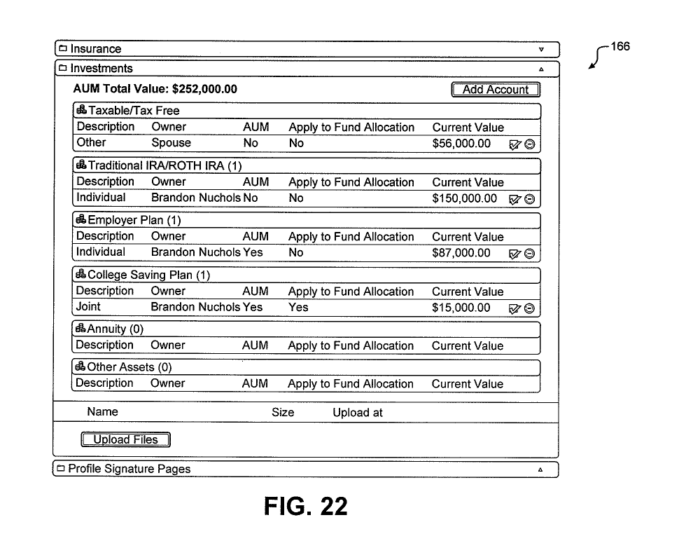

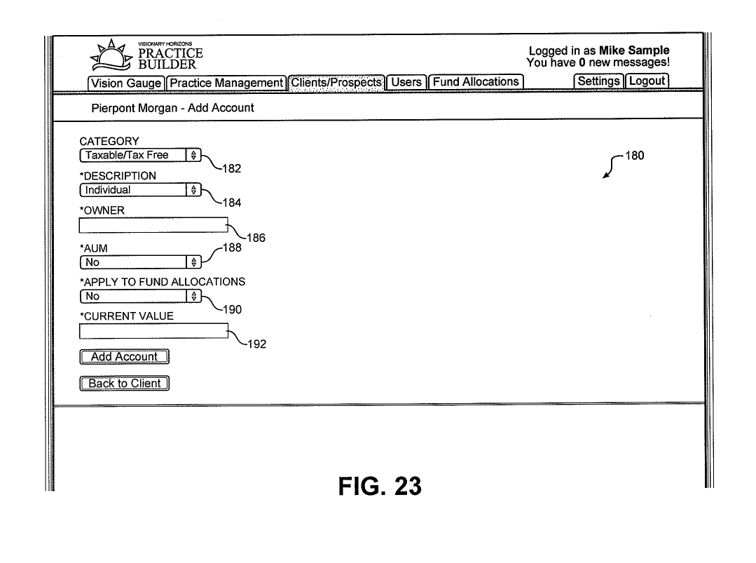

Referring now to FIG. 22, a user can create one or more asset accounts 176 by entering information or uploading information to the investment folder 166. An asset account 176 is a collection of funds that the customer holds. When a user selects an add account button 178, an add account webpage 180 is loaded where the user can input various information relating to the asset account 176, an example of which is shown in FIG. 23. The add account webpage 180 includes a category field 182, a description field 184, an owner field 186, an asset under management (“AUM”) field 188, an investable asset field 190 and a value field 192. Using the category field 182, a user can define the type of the asset account including, for example, a taxable/tax free account, an IRA, employer plans, college savings plan, annuities, or other types of assets. The description field 184 is used to define the ownership of the asset account including, for example, whether it is owned solely, jointly or some other ownership arrangement. The owner field 186 allows a user to define the owners of the asset account. The AUM field 188 allows the user to designate whether the asset account 176 is being managed by the financial advisor or by someone else, such as an employer. The AUM field 188 is useful for assisting the financial advisor in determining the amount of funds that he or she manages or does not manage on behalf of the customer. Finally, the value field 192 allows the user to input the value of the asset account 176 when it is first created.

The document upload and saving features of the system 10 are particularly useful for assisting the financial advisor in complying with documentary and reporting requirements imposed by various regulatory organizations. For example, the system may be used to ensure compliance of the financial advisor with rules and regulations enforced by state regulatory agencies, the Securities and Exchange Commission (SEC), the Financial Industry Regulatory Authority (FINRA), and the Municipal Securities Rulemaking Board (MSRB).

As an example, one FINRA regulation, relating to electronic books and records, requires that all records be made and maintained for the purpose of review and auditing of client files including electronic correspondence such as email and instant messages. Under this regulation, FINRA requires financial advisors to enact policies or employ methods for filtering and sampling of these documents for review.

To ensure compliance with these and other regulations, the system 10 allows a user to upload and save all documents relating to customers and to the financial advisors including, for example, notes, dictation, correspondence, filings, and trading documents. These documents can be stored in the database 34 in association with a user profile 60 and/or a customer profile 102 so that they are searchable and quickly accessible. One skilled in the art will recognize, however, that the system 10 may be used to ensure compliance of the financial advisor with requirements, regulations or laws other than those implemented by FINRA or the SEC. Thus, the inventions described are not limited only to a system for ensuring compliance of the financial advisor with a plurality of documentary and reporting requirements promulgated and enforced by the SEC and FINRA.

Investment Phase

As previously mentioned, the system 10 includes a fund allocation module 40, which includes computer-executable instructions that, when executed, assist the financial advisor in selecting investments and allocating funds to those selected investments. The fund allocation module 40 allows a financial advisor to store information related to stocks and bonds, build investment models including those stocks and bonds, and suggests the investment allocation of customer funds into one or more of those stocks and bonds. The fund allocation module 40 can also be utilized in determining the suitability of particular investments to the investment style and risk tolerance of the customer.

After all required customer information and necessary documentation has been acquired and stored in the database 34 during the initial customer contact phase 12, the customer may choose to begin their investment activities (i.e., the investment phase). Typically, financial advisors choose their customers' investments and build a portfolio according to an investment model 194 (FIG. 24). An investment model 194 may include stocks and/or bonds in varying percentages.

As shown in FIG. 24, when the user selects suitability info tab 144, the application 36 executes the fund allocation module 40 and displays the suitability and risk tolerance webpage 146. In addition to displaying portions of the suitability information entered into the new customer webpage 106 (FIG. 16), the suitability and risk tolerance page 146 represents graphical representations of investment models 194. Each investment model 194 displays varying allocations of stocks and bonds. The risk of investment depends on the type of investment made. Historically, stocks are known to be more risky investments but can yield in a higher rate of return, whereas bonds are known to be more conservative but yield a lower rate of return. Therefore, investment models 194 typically range from a “conservative” model, where funds are invested solely in bonds, to an “aggressive” model, where funds are invested solely in stocks. As further explained below, these models are created by the application 36 based on suitability and risk tolerance information specific to each customer.

A financial advisor often assists a customer in determining which investment model 194 is best suited for the customer's investment style and risk tolerance. The financial advisor may gather this information in a number of ways including, for example, by talking with the customer or by reviewing the investment history of the customer. Alternatively, a financial advisor may present the customer with a questionnaire that is designed to gauge the risk tolerance of the customer and define the customer's investment style. Thus, according to some embodiments of the present invention, this information may be collected and stored via a risk tolerance assessment 18 (step 320) as shown in FIG. 25.

The risk tolerance assessment 18 may be accessed by selecting a risk assessment button 196 (FIG. 24). As shown in FIG. 25, the risk tolerance assessment 18 provides a series of assessment questions 198 that are answered by the customer or by the financial advisor on behalf of the customer, and that are designed to gauge the suitability of investments for the customer. The risk tolerance assessment 18 also assists the financial advisor in determining an investment strategy that is appropriate for the customer's current needs. The assessment questions 198 may include, for example, (1) what types of risks a customer is willing to take, (2) customer's investment goals, (3) the timeframe the customer has set for achieving those investment goals, (4) when the customer expects to begin withdrawing funds, and (5) other information that would assist in determining an appropriate investment portfolio. The questionnaire 18 is based on a scoring system. Each question is assigned a total maximum point value and each answer response is given different point values. When the customer completes the questionnaire 18, a risk tolerance score is tabulated and is an indication of that customer's risk tolerance.

Once the risk tolerance score is calculated and saved to the system 10, the financial advisor can create one or more investment models 194 that suit the needs of that particular customer. Investment models 194 provide a set of recommended investments that the customer should make that would be suitable for the customer's investment goals and risk tolerance. These models are based on the risk tolerance score, the amount of investable funds, and the funds selected for the funds table 74 (FIG. 8). In a preferred embodiment, the fund allocation module 40 automatically generates the investment models 194 based the risk tolerance score, the amount of investable funds, and the funds selected for the funds table 74. In certain embodiments, the fund allocation module 40 provides suggested specific amounts of funds that should be allocated to each fund (i.e., stock or bond) in the investment model 194.

Referring again to FIG. 24, one or more of the investment models 194 may be selected as a recommended model 22 for the customer. The recommended model 22 is the model that most closely fits the customer's investment style and risk tolerance. The fund allocation module 40 selects the recommended model 22 by default, but the user is free to override this choice and select a different investment model 194. Thus, either the recommended model 22 or another investment model 194 may be designated in the fund allocation module 40 as a customer-selected model 202. The customer-selected model 202 is used in investing the funds of the customer (step 322). This model includes the customer's portfolio decision information, which may include the selected funds that he customer has selected to invest in and also the amount of the customer's investable assets that will be allocated to each fund. In a preferred embodiment, the system 10 may be configured to automatically invest the customer's investable assets into the customer-selected model 202 after the selection is made.

After the customer-selected model 202 has been designated in the fund allocation module 40, an investment confirmation is printed by the system 10. The investment confirmation summarizes the investment choices recommended by the financial advisor including, for example, the amount of money to be invested and the types of stocks and/or bonds to be purchased. In a preferred embodiment, prior to any investment activities, the system 10 prompts the customer to sign or approve the investment confirmation and an electronic version of the confirmation is uploaded to the system 10. Uploading a signed investment confirmation ensures that the customer is aware of and agrees to the use of his or her funds for the selected investments and it also provides a signed record for compliance purposes. The system 10 or, alternatively, the financial advisor then makes all investments that have been approved in a signed investment confirmation.

Monitoring Phase

Once the investments have been made, the advisor can view a summary of the investment activity for the customer using an allocations page as shown in FIG. 26. The allocations page 154 can be accessed by selecting the portfolio allocations tab 152. The allocations page 154 provides an allocated funds field 206, which provides an investment summary report that summarizes the total amount of funds that have been invested, and a non-allocated funds field 208, which provides the total amount of funds that have not been invested. Finally, a portfolio allocation table 210 provides a summary of the total amount of invested funds according to each investment.

Both the allocated funds field 206 and the non-allocated funds field 208 display information relating to each asset account 176 including the category of asset, a description of the type of ownership, the name of the owner(s), whether the asset account is an AUM of the financial advisor, and the value of the asset account when it was first invested. In some preferred embodiments, an updated value field is provided and allows a user to input the value of the assets at a later time. The updated value field can be updated from time to time by the financial advisor to reflect the changing value of the asset account 176 due to changes in market conditions.

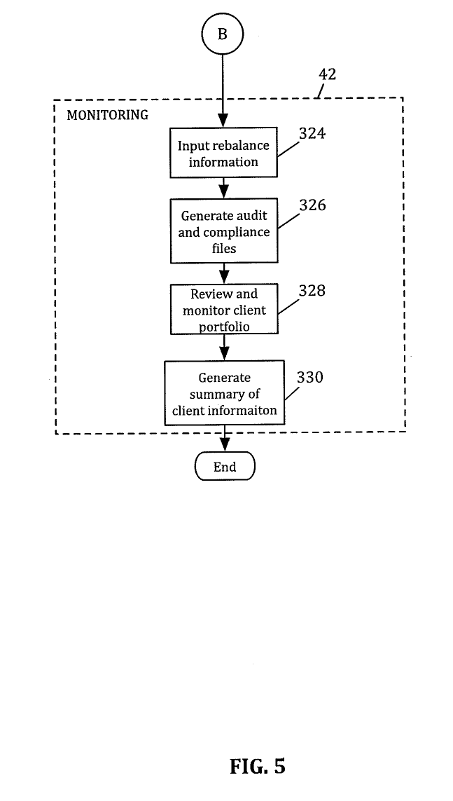

This feature is useful in determining if a “rebalance” of the customer's account is required. If the financial advisor finds that the initial value of the asset account and the current value of the asset account are not equal, the financial advisor can either buy additional shares or sell shares (i.e., rebalance) to make the current value of the asset account equal to the initial value of the account (step 324) in FIG. 5. For example, if the current value of a first asset account is higher than its initial value and the current value of a second asset account is lower than its initial value, the financial advisor could sell a portion of the shares in the first asset account and, with the resulting funds, purchase additional shares for the second asset account. This rebalance procedure may be required several times throughout the year (e.g., semi-annually), and the financial advisor can set up a rebalance meeting for this task. This task is specific to each advisor. A portfolio rebalance may also be required if the financial advisor modifies the funds that comprise the funds table 74. When the funds are modified, the application 36 will also adjust the investment models 194 to incorporate those new funds.

In some embodiments, the fund allocation module 40 also provides research on stocks and bonds for each of the investment models as well as any other stocks and/or bonds that are stored in the database 34. This research may be system generated or may be uploaded by a user of the fund allocation module 40. Also, the research may be provided throughout the year at various time intervals. For example, a monthly report, a quarterly report, and/or a yearly report may be provided with each of the designated models or stocks or bonds.

As seen in FIG. 27, the customer profile 102 also includes an appointment checklist 214 that can assist the financial advisor in tracking tasks for the individual customer. The user can browse to this appointment checklist 214 on the appointment checklist page 150 by selecting the apt. checklist tab 148. The appointment checklist 214 provides a list of tasks, discussion topics, documents or objectives that the financial advisor should address and provide to the customer during the course of interacting with that customer. The checklist 214 may also be beneficial as a final check by the advisor to ensure that all tasks relating to a customer have been completed.

The tasks included in the checklist 214 are divided into multiple categories and include, for example, status, product review, taxes, legal, planning, transactions, documents for meeting, appointment follow up, and a next appointment/agenda section. For example, under “planning,” the checklist contains three items that should be addressed by the financial advisor while interacting with the customer: (1) risk tolerance, (2) goals/objectives, and (3) trades/transfers/deposits.

As the advisor addresses the issues related to these three items they check the corresponding checkbox. During the interactions with the customer, the advisor continues to check off the items on the checklist 214 until all required items have been completed. For instance, once the customer has completed the risk tolerance questionnaire 18, the advisor places a check on the checkbox corresponding to “risk tolerance.” An appointment date field 220 can be used to indicate the date of the interaction with the customer where the items were completed. Finally, a next appointment field 222 is provided to remind the financial advisor whether another appointment should be scheduled as well as the details related to that appointment. In a preferred embodiment, the application 36 is configured to automatically generate meeting worksheets, meeting reminders and other documents for the financial advisor for use during scheduled meetings with customers. While hard copies of these worksheets may be printed for the financial advisor, they are preferably displayed on the financial advisor computer 28. These worksheets may include information that is helpful to the financial advisor including, for example, relevant customer data, discussion topics for the meeting, and upcoming tasks or deadlines. The worksheets also provide notes space for the financial advisor to provide a discussion of the meeting and any decisions made during the meeting. In a preferred embodiment, the application 36 provides the financial advisor with a dictation tool for attaching dictation relating to the meeting. In a more preferred embodiment, that dictation automatically populates the notes section of the worksheet.

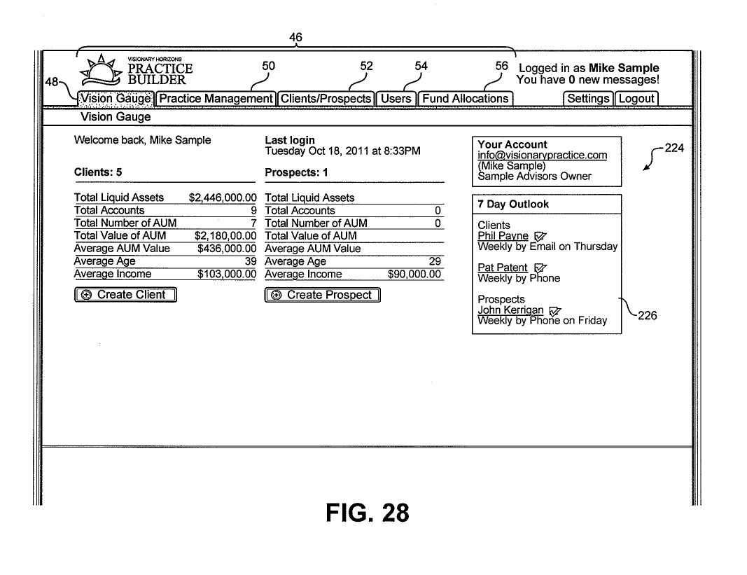

Next, the user can access a Vision Gauge™ webpage 224 by selecting the Vision Gauge™ button 48, an example of which is shown in FIG. 28. The Vision Gauge™ webpage 224 provides the user a snapshot or overview of all customers and their contact information. For example, using the Vision Gauge™ webpage 224, the user can determine the number of customers and prospective customers that have been entered into the system 10, the total amount of assets for those customers and other customer demographics, the total number of accounts, etc. Additionally, the Vision Gauge™ webpage 224 provides the user with industry averages and other averages that are useful in the financial investment industry. These averages can be used by the advisor and the customer to evaluate the growth of various investments and business growth. Additional field may be added to this webpage (e.g., revenue amounts, average fee percentage, etc.).

Additionally, the Vision Gauge™ webpage 224 includes an outlook field 226 that provides the user various reminders and calendars. The information displayed in the outlook field 226 may be generated based on information from several sources, including information entered and stored in the application 36 or from information accessed via the Internet 30. For example, the outlook field 226 will display meeting reminders for each customer based on the information entered into the contact preferences section 114 of that particular customer's customer profile 102. Additionally, the outlook field 226 may provide a list of upcoming or incomplete tasks for each customer. For example, the outlook field 226 may instruct the financial advisor when to schedule contact with a customer and how the customer wishes to be contacted. This may be based on information input into the customer's profile 102, including information entered into checklist 214 (FIG. 27). The outlook field 226 may be configured to display information for a single date or for a range of dates (e.g., the next 90 days). Additionally, the outlook field 226 may be configured to send reminders to the financial advisor using various means including email messages or text messages.

What is claimed is:

1. A method for managing records of a financial advisor practice performed using one or more computers comprising a processor, storage, and a memory, and a financial advisor management application comprising computer-executable instructions executed on the one or more computers, the method comprising the steps of:
receiving financial advisor information regarding a financial advisor and storing the financial advisor information in the memory;
receiving customer information regarding a customer of the financial advisor and storing the customer information in the memory, wherein the customer information includes an amount of investable assets associated with the customer;
generating a financial advisor profile for the financial advisor based on the financial advisor information;
generating a customer profile for the customer based on customer information;
linking the customer profile to the advisor profile;
receiving risk tolerance information for the customer and storing that information in the memory;
generating one or more unique investment models based on the customer information and the risk tolerance information and providing those models to the customer, each of the investment models comprising one or more funds in which a customer may allocate at least a portion of the investable assets associated with the customer;
receiving portfolio decision information for the customer and storing that portfolio decision information in the memory, the portfolio decision information including information indicating selected funds that the customer has selected from the one or more funds to invest in and amounts of the investable assets allocated to each of the selected funds;
generating for the financial advisor at least one customer contact reminder for the customer; and
generating an audit/compliance file for the customer, wherein the audit/compliance file provides documentation sufficient to meet compliance requirements of at least one securities regulatory body.

2. The method of claim 1, wherein the at least one securities regulatory body includes state regulatory agencies, the Securities and Exchange Commission, the Financial Industry Regulatory Authority, and the Municipal Securities Rulemaking Board.

3. The method of claim 1 further comprising the step of generating a portfolio management reminder, wherein the portfolio management reminder reminds the financial advisor of a scheduled meeting or of a scheduled rebalance and is based, at least in part, on the financial advisor information, customer information and risk tolerance information.

4. The method of claim 1 further comprising the step of applying one or more access restrictions or permissions to at least one of the financial advisor profile and customer profile to limit or grant access to one or more features of the financial advisor management application.

5. The method of claim 1 further comprising the step of automatically generating one or more forms prefilled using one or more of the financial advisor information, customer information, and risk tolerance information.

6. The method of claim 1 further comprising the step of collecting at least a portion of the risk tolerance information using a risk tolerance questionnaire, wherein the risk tolerance questionnaire includes one or more questions and wherein a risk tolerance score is assigned based on responses to those one or more questions and wherein the risk tolerance score is a quantitative measure of the risk tolerance for the customer.

7. The method of claim 1, wherein the one or more investment models comprises one or more suggested investment models that are automatically generated by the application and are based, at least in part, on the customer information and one or more characteristics of the funds in the investment models.

8. The method of claim 7, wherein the customer information includes a risk tolerance score that is a quantitative measure of the risk tolerance of the customer and the one or more characteristics of the funds includes a risk indicator that indicates the riskiness of the funds.

9. The method of claim 7, wherein the suggested investment models are automatically generated by the system using the financial advisor information, customer information and risk tolerance information and wherein each investment model provides a collection of one or more suggested funds and suggest an amount of the customer's investable funds that should be allocated to each of the suggested funds.

10. The method of claim 1 further comprising the step of uploading at least one document to the system and saving the document to the audit/compliance file.

11. The method of claim 10 further comprising the step of date and time stamping the at least one document.

12. The method of claim 1 wherein the portfolio decision information includes an investment authorization from the customer, the investment authorization authorizing the financial advisor to invest at least a portion of the investable funds into the one or more funds in amounts specified by the customer on behalf of the customer, and wherein the investment authorization must be signed by the customer and saved to the system before a financial advisor can implement the investment decision.

13. The method of claim 12 further comprising the step of generating an investment confirmation that summarizes the investment decision.

14. The method of claim 1 further comprising the step of generating an investment summary report, which summarizes the total amount of investable funds for the customer, the total amount of the investable funds that have been invested and have not been invested, and the amount of the investable funds invested into each of the one or more funds.

15. The method of claim 14 further comprising the step of generating an investment summary recommendation report for each customer profile associated with a selected financial advisor profile.

16. The method of claim 1 further comprising the step of generating a task checklist associated with the customer profile, wherein the checklist provides one or more of a list of tasks, discussion topics, documents or objectives that the financial advisor should provide or meet during the course of interacting with the customer, and documentation required to ensure compliance with requirements of at least one securities regulatory body.

17. An interactive system for managing records of a financial advisor, the system comprising:
communication means for sending and receiving financial advisor information for a financial advisor;
processing means for processing the financial advisor information;
database means for storing the financial advisor information;
customer contact means for sending and receiving customer information for a customer of the financial advisor;
uploading mean for uploading files for storage on the database means;
model generation means for generating at least one custom investment model for the customer based on the customer information; and
regulatory compliance means for generating a customer audit file for the customer to ensure compliance of the financial advisor with an industry regulatory audit and for storing the customer audit file to the database means.

18. An interactive system comprising computer-executable instructions for managing records of a financial advisor by a service provider on behalf of the financial advisor, the system comprising:
a service provider computer in communication with a financial advisor computer via a communication network, the service provider computer comprising computer-executable instructions for executing a financial advisor management application to receive financial advisor information via the communication network and process the financial advisor information in managing the records of the financial advisor;
the financial advisor management application configured for execution on the service provider computer to provide a user interface displayed on the financial advisor computer, the user interface configured to prompt the financial advisor to input financial advisor information via multiple system tools, and the user interface further configured to provide the financial advisor with access to the financial advisor information, wherein the financial advisor information is associated with a financial advisor account maintained by the service provider for the financial advisor;
the system tools including a contact management tool, an electronic filing tool, a notes tool, a risk tolerance questionnaire, a regulatory compliance tool, a model generation tool, and a financial advisor summary tool;
a financial advisor records database in communication with the service provider computer, the financial advisor records database comprising computer-executable instructions for storing the financial advisor information associated with the financial advisor account;
the contact management tool comprising computer-executable instructions for prompting the financial advisor to input information relating to prospective customers and existing customers into a customer file including customer contact information, customer preferences, customer tasks, customer assets, customer investments and existing relationships between a customer and tax advisors, legal advisors, or financial advisors, wherein the financial advisor can update the status of the customer in the customer file from prospective customer to existing customer while retaining the contents of the customer file;
the electronic filing tool comprising computer-executable instructions for allowing the financial advisor to upload files for storage in the financial advisor records database including dictation and word processor documents;
the risk tolerance questionnaire comprising computer-executable instructions for providing questions to the customer and, based on those questions, determining a suggested investment model for that customer which the customer may elect to use or not to use, wherein the risk tolerance questionnaire is further operable to provide an investment summary which summarizes investment decisions made by the customer, wherein the investment summary is to be signed by the customer prior to any of the investment activities being carried out, and wherein the investment summary is saved to the financial advisor records database;
the regulatory compliance tool comprising computer-executable instructions for monitoring the financial advisor information and generate a customer audit report for complying with various financial audit requirements, the customer audit report providing financial advisor information stored on the financial advisor records database that is required for compliance with an industry regulatory audit;
the model generation tool comprising computer-executable instructions for providing one or more financial advisor models, wherein each model consists of a unique allocation of at least a portion of a customer's investable assets to stocks, bonds, or both and result in varying degrees of financial risk, wherein the model generation tool is further operable to provide research related to each of the models, and suggest one or more of the models based on the risk tolerance questionnaire; and
the financial advisor summary tool comprising computer-executable instructions for providing a summary of customers, customer contact information, customer assets, customer investments, and customer tasks to be performed by the financial advisor relating to each customer.
